(19) United States
(12) Patent Application Publication
(10) Pub. No.: US 2024/0275193 A1
(43) Pub. Date: Aug. 15, 2024

(54) AUTONOMOUSLY OPERABLE BATTERY MODULE FOR A BATTERY SYSTEM AND BATTERY SYSTEM

(71) Applicant: DEUTSCHES ZENTRUM FÜR LUFT- UND RAUMFAHRT E.V., 53227 Bonn (DE)

(72) Inventors: Marius EILENBERGER, Stuttgart (DE); Hariharan GUNASEKAR, Stuttgart (DE)

(73) Assignee: DEUTSCHES ZENTRUM FÜR LUFT- UND RAUMFAHRT E.V., 53227 Bonn (DE)

(21) Appl. No.: 18/432,164

(22) Filed: Feb. 5, 2024

(30) Foreign Application Priority Data
Feb. 10, 2023 (DE) 20 2023 100 64

(51) Int. Cl. H02J 7/00; B64G 1/22; B64G 1/42; H01M 10/42; H01M 10/44; H01M 10/46; H01M 10/48; H01M 10/637; H01M 50/213

(52) U.S. Cl. CPC H02J 7/0045; B64G 1/223; B64G 1/425; B64G 1/428; H01M 10/425; H01M 10/441; H01M 10/443; H01M 10/46; H01M 10/486; H01M 10/637; H01M 50/213; H02J 7/00032; H02J 7/0014; H02J 7/0047; H02J 7/007182; H01M 2010/4278; H01M 2220/20

(57) ABSTRACT

An autonomously operable battery module for a battery system of a satellite or spacecraft is provided with a carrier board on which a plurality of battery cells and operating components for temperature control of the battery cells for charge balancing between the battery cells and for monitoring the battery cells are arranged, wherein communication equipment is also present on the carrier board for communication with the battery system and further battery modules in the battery system, and connection equipment for electrical series and/or parallel coupling with one or more other similar battery modules are arranged on the carrier board.

### BACKGROUND AND SUMMARY

The invention relates to an autonomously operable battery module for a battery system, in particular of a satellite or spacecraft, with a plurality of battery cells and to a battery system of a satellite or spacecraft with at least one battery module.

In space applications proven technology is usually used. This means that components that are years or decades old are being used. These have been tried and tested and have proven flight-ready in many satellites for many years. However, these components are also simple and outdated. When it comes to Li-ion battery cells, this means that there are already new generations with better power density. When it comes to electronic components in battery management, there are microcontrollers and circuits that enable more functionality. In larger space systems, analog circuits are usually used in battery systems. In addition, usually only the total voltage and temperatures are monitored at a few points in the battery system.

In space travel, increased qualifications are also necessary to demonstrate the functionality of components, for example a battery system.

It is desirable to create a cost-effective, autonomous battery module for a battery system of a satellite or spacecraft with a plurality of battery cells.

It is also desirable to create a cost-effective battery system for a satellite or spacecraft with at least two battery modules that can be operated autonomously.

It is also desirable to specify a method for operating a cost-effective battery system of a satellite or spacecraft with at least two autonomously operable battery modules.

According to an aspect of the invention, an autonomously operable battery module for a battery system of a satellite or spacecraft is proposed, with a carrier board on which a plurality of battery cells and operating components for temperature control of the battery cells, for charge balancing between the battery cells and for monitoring the battery cells are arranged. Furthermore, communication means are present on the carrier board for communication with the battery system and other battery modules in the battery system. Connection means for electrical serial and/or parallel coupling with one or more other similar battery modules are arranged on the carrier board.

The proposed autonomously operable battery module advantageously enables the realization of battery systems, in particular for space applications such as satellites, with commercial components, also referred to as so-called Commercial Off-The-Shelf (COTS) components. The battery module in particular forms a base module, from which various battery systems with greater electrical power and/or greater electrical voltage and/or electrical capacity can be formed by adding further, preferably identical battery modules. The battery module can be qualified for use in a satellite or spacecraft. This means that further, usually very complex, qualification processes of battery systems constructed from such identical battery modules can be omitted.

Due to the scalability of the proposed battery module, modular battery systems can be provided, in which the battery modules can be connected in parallel and/or series and so voltage, and/or current, and/or capacity can be easily adjusted for each space mission. Such battery modules can be interconnected in a suitable manner and form battery systems with different voltage levels, and/or different power, and/or different energy content. For this purpose, the battery modules have the necessary connection means for parallel and serial connection as well as communication means for communication with other battery modules or the battery system. Connection means can be, for example, the plug connectors for the positive power connection and ground connection as well as plug connectors for data lines for controlling charge balancing of the battery cells.

A regulation and/or control device as well as a unit for monitoring and/or charge balancing between the battery cells can advantageously enable the collection of data from each individual battery cell and the processing of the data using algorithms in the battery module itself. But communication of data to earth is also possible. In addition, some operating parameters, such as heating and charge balancing, can be adjusted during operation. Above all, adaptive charge balancing, in which the end-of-charge voltage can be changed, is important for the operation of satellites or spacecraft. Here, a lower end-of-charge voltage can initially increase the lifespan of the battery cells. Later in the life cycle of the satellite or spacecraft, a higher end-of-charge voltage can increase the mission time of the satellite or spacecraft by providing more energy.

Monitoring the battery cells by means of the unit for monitoring and/or charge balancing and processing the data in the regulation and/or control device make it possible to use complex algorithms to determine the state of charge (State Of Charge=SOC) and the aging state of the battery cells (State Of Health=SOH). SOC and SOH give the operator, for example of the satellite, insights into the condition of the battery cells and the entire battery system. The operator thus conveniently receives detailed information about what charge is still available for the current operation or about the time the satellite can still be operated safely. Advantageously, even more complex circuits for space travel can thus be qualified with reasonable effort.

The carrier board, for example a standard printed circuit board, serves as the base of the battery module. The electronic components are arranged on the carrier board. The board has connection points for battery cells, power supply, ground, communication, sensors and interconnection with other battery modules or with a battery system.

The electronic components jointly take on tasks such as monitoring the battery module and the battery cells, for example through voltage, current and temperature. Furthermore, an analysis of the battery module can be carried out, for example a calculation of SOC and SOH of the battery cells, and/or a comparison of the values with set limits. The battery module can be managed by controlling the charge balancing and heating of the battery cells. The electronic components also communicate data to the outside and process commands from outside. The components ensure protection of the electronics and battery cells against errors and/or short circuits in semiconductors caused by radiation from space, so-called single event effects, or can also correct such errors under certain circumstances.

The carrier board can also have holding devices for holding the battery cells, so it also serves as a structural component for the battery cells. In addition, the carrier board can also have operating components for monitoring and controlling the thermal balance of the battery cells. In this way, the carrier board ensures mechanical and thermal stability of the battery module.

The battery modules can advantageously be stackable, for example, and thus enable the construction of a compact battery system with upgradeable current and capacity.

According to a favorable embodiment of the battery module, the carrier board can have first and second holding devices. The battery cells can be clamped between a first and a second holding device. Advantageously, the holding devices on the positive and negative poles of the battery cells can be made of a preferably non-electrically conductive but lightweight material or coated with a plastic. Polyether ether ketone (PEEK), for example, is a favorable plastic. Advantageously, the first and second holding devices can encompass the battery cells at least partially on their circumference at opposite ends. In this way, cylindrical cells in particular can be accommodated safely and in a mechanically stable manner. Vibration requirements, such as those required in space travel, can also be advantageously met.

According to a favorable embodiment of the battery module, one of the first holding devices can be arranged on opposite side edges of the carrier board. Battery cells can thus advantageously be clamped between the first holding devices.

According to a favorable embodiment of the battery module, the second holding devices can be arranged, in particular centrally, between the first holding devices. The second holding device can advantageously be designed to fix battery cells arranged on both sides of the second holding device. This makes it possible to save space and weight.

According to a favorable embodiment of the battery module, the battery cells can be arranged lying on the carrier board. In particular, the battery cells can be designed as cylindrical cells; cylindrical cells can be used inexpensively as commercial battery cells from mass production.

According to a favorable embodiment of the battery module, the battery cells can be arranged next to one another and/or one behind the other with respect to their longitudinal axis, wherein the battery cells on the carrier board are or can be electrically connected in parallel and/or in series. This enables a modular structure of the battery module with a variety of interconnection options. In this way, desired voltage levels can be easily achieved or capacity requirements can be met.

According to a favorable embodiment of the battery module, structural elements which are designed for passive temperature control of the battery cells can be arranged at least in regions between adjacent battery cells. The structural elements can be adapted to an external shape of the battery cells at least in some regions. In particular, the structural elements can have a negative contour of the battery cells in some regions and nestle up against the battery cells. Metallic structural elements can advantageously dissipate heat. Advantageously, the structural elements can be made of or coated with a material that is preferably thermally conductive. The material can be aluminum, for example. The structural elements can be designed for passive temperature control of the battery cells. This allows the thermal balance of the battery cells to be advantageously controlled.

According to a favorable embodiment of the battery module, the structural elements can be integrated into the holding devices. This makes it possible to advantageously save installation space. In addition, the assembly of the battery modules can be made easier.

According to a favorable embodiment of the battery module, the carrier board can have one or more heating elements. In particular, one or more heating elements can be integrated into the structural elements. The heating elements can advantageously bring the battery cells to the necessary operating temperatures. This feature is particularly important for space applications when the satellite experiences cooling due to radiation losses in positions facing away from the sun.

According to a favorable embodiment of the battery module, one respective heating element can be provided for simultaneously heating at least two adjacent battery cells on the carrier board. This makes it possible to advantageously reduce the number of components and thus the costs.

According to a favorable embodiment of the battery module, the carrier board can have one or more temperature sensors, which are provided for thermally contacting the battery cells. In this way, the temperature of each battery cell can advantageously be determined and a detailed overview of the condition of the battery module can be obtained.

According to a favorable embodiment of the battery module, connection poles of the battery cells can be electrically connected to current paths on the carrier board using cell connectors. In particular, there can be one cell connector per connection pole. The current paths can be accessible through, for example, slot-like receptacles in the carrier board. In particular, a separate cell connector can be provided at each connection pole of the battery cells. The battery cells can be electrically contacted flexibly and easily in a desired interconnection. The cell connectors can be made of aluminum, for example.

According to a favorable embodiment of the battery module, the carrier board can have at least one unit for monitoring and balancing the charge of the battery cells in at least one free space between the battery cells. In this way, the battery module's condition can be monitored in detail. Depending on the electronic components used, charge balancing can be done passively or actively. With passive charge balancing, all battery cells of the battery module are adjusted to the lowest voltage of a battery cell of the battery module by consuming excess electrical charge, for example in a resistor. Active charge balancing allows electrical charge to be shifted from a higher voltage battery cell to a lower voltage battery cell. This allows an average voltage of the battery cells of the battery module to be set.

The unit for monitoring and charge balancing of the battery cells can advantageously be designed to selectably adjust an end-of-charge voltage of the battery cells. In this way, an adaptive charge balancing of the battery cells can take place, in which the end-of-charge voltage can be changed. Here, for example, a lower end-of-charge voltage at the start of the mission can increase the service life of the battery cells. Later in the life cycle of the satellite or spacecraft, a higher end-of-charge voltage can increase the mission time of the satellite or spacecraft by providing more energy.

According to a favorable embodiment of the battery module, the carrier board can have at least one regulation and/or control device, in particular a microcontroller, in at least one free space between the battery cells for controlling charging and discharging operation of the battery cells.

In particular, the regulation and/or control device can be designed to determine a state of charge and/or an aging state of the battery cells. In this way, the battery module can be monitored in detail and an overall condition of the battery module can be determined with a forecast for the further service life of the battery cells.

According to a favorable embodiment of the battery module, the carrier board can have at least one CAN transceiver in at least one free space between the battery cells for communication with other battery modules and/or the battery system. CAN networks are widespread communication applications, particularly in the automotive sector, which can also be used cost-effectively and very flexibly in battery modules.

According to a favorable embodiment of the battery module, the first and second holding devices of the carrier board can be designed for mechanical connection to a carrier board of a further battery module stacked above it and/or a termination board. The holding devices as structural components of the battery module can conveniently accommodate additional stacked battery modules and form a mechanically stable assembly.

According to a further aspect of the invention, a battery system of a satellite or spacecraft is proposed, having at least two autonomously operable battery modules. The at least two battery modules are constructed identically and each has a carrier board on which a plurality of battery cells and operating components for temperature control of the battery cells, for charge balancing between the battery cells and for monitoring the battery cells are arranged.

Furthermore, communication means are present on the carrier board for communication with the battery system and the at least one additional battery module in the battery system. The at least two battery modules are electrically coupled in series and/or parallel by means of connection means which are arranged on the carrier board.

The battery module in particular forms a base module, from which various battery systems with greater electrical power and/or greater electrical voltage and/or electrical capacity can be formed by adding further, preferably structurally identical battery modules. The battery module can be qualified for use in a satellite or spacecraft. This means that further, usually very complex, qualification of battery systems constructed from such identical battery modules can be omitted.

The proposed battery system for space applications such as satellites can advantageously be implemented with commercial components, also referred to as Commercial Off-The-Shelf (COTS) components.

The proposed battery system is modular and scalable because it has battery modules that can be operated autonomously and can each be connected in parallel and/or series. This means that the voltage, and/or current, and/or capacity of the battery system can be easily adjusted for each space mission. Such battery modules can be interconnected in a suitable manner and form battery systems with different voltage levels, and/or different power, and/or different energy content.

For this purpose, the battery modules have the respective interfaces for parallel and serial connection as well as for communication with other battery modules or the battery system. For this purpose, the battery modules have the necessary connection means for parallel and serial connection as well as communication means for communication with other battery modules or the battery system. Connection means can be, for example, the plug connectors for the positive power connection and ground connection as well as plug connectors for data lines for controlling charge balancing of the battery cells.

A regulation and/or control device as well as a unit for monitoring and/or charge balancing between the battery cells can advantageously enable the collection of data from each individual battery cell and the processing of the data using algorithms in the battery module itself. But communication of data to earth is also possible. In addition, some operating parameters, such as heating and charge balancing, can be adjusted during operation. Above all, adaptive charge balancing, in which the end-of-charge voltage can be changed, is important for the operation of satellites or spacecraft. Here, a lower end-of-charge voltage can initially increase the lifespan of the battery cells. Later in the life cycle of the satellite or spacecraft, a higher end-of-charge voltage can increase the mission time of the satellite or spacecraft by providing more energy.

Monitoring the battery cells by means of the unit for monitoring and/or charge balancing and processing the data in the regulation and/or control device make it possible to use complex algorithms to determine the state of charge (State Of Charge=SOC) and the aging state of the battery cells (State Of Health=SOH). SOC and SOH give the operator, for example of the satellite, insights into the condition of the battery cells and the entire battery system. The operator thus conveniently receives detailed information about what charge is still available for the current operation or over how long the satellite can still be operated safely. Advantageously, even more complex circuits for space travel can be qualified with reasonable effort.

The carrier board, for example a standard printed circuit board, serves as the base of the battery module. The electronic components are arranged on the carrier board. The board has connection points for battery cells, power supply, ground, communication, sensors and interconnection with other battery modules or with a battery system.

The electronic components jointly take on tasks such as monitoring the battery module and the battery cells, for example through voltage, current and temperature. Furthermore, an analysis of the battery module, for example a calculation of SOC and SOH of the battery cells, and/or a comparison of the values with set limits can be carried out. The battery module can be managed by controlling the charge balancing and heating the battery cells.

The electronic components also communicate data to the outside and process commands from outside. The components ensure protection of the electronics and battery cells against faults and/or short circuits in semiconductors caused by radiation from space, so-called single event effects, or can also correct such errors under certain circumstances.

The carrier board can also have holding devices for holding the battery cells, so it also serves as a structural component for the battery cells. In addition, the carrier board can also have operating components for monitoring and controlling the thermal balance of the battery cells. In this way, the carrier board ensures mechanical and thermal stability of the battery module.

The battery modules can advantageously be stackable, for example, and thus enable the construction of a compact battery system with upgradeable current and capacity.

According to a favorable embodiment of the battery system, the at least two battery modules can be arranged in a battery housing. In particular, at least one of the battery modules can be completed with a termination board, which is arranged on a holding device of the at least one battery module. In particular, the topmost battery module in a stacking direction can be terminated with the termination board. Such a battery housing, for example made of two housing parts, can be assembled inexpensively. The termination board represents a cover for the top battery module. This means that the battery modules can be easily removed or replaced, for example in the event of a fault or to change the required circuitry.

According to a favorable embodiment of the battery system, the battery housing can have respective holders for fixation with a mounting plate, in particular with a mounting plate of the satellite or spacecraft. Alternatively or additionally, the battery housing can have at least one electrical plug connector for power supply and/or for transmitting data. The housing parts can easily be mounted on a satellite platform and connected electrically, for example.

According to a favorable embodiment of the battery system, the termination board can have at least one electrical connection for an onboard data connection and/or an electrical connection for programming a regulation and/or control device, in particular a microcontroller. The termination board can be used to easily communicate electrically with the battery system. In addition, configurations and programming can be carried out advantageously.

To operate a battery module that can be operated autonomously, a final charging voltage of the battery cells can advantageously be selected according to operating parameters and/or set by means of a unit for monitoring and balancing the charge of battery cells. Above all, adaptive charge balancing, in which the end-of-charge voltage can be changed, is important for the operation of satellites. Here, a lower end-of-charge voltage can initially increase the lifespan of the battery cells. Later in the life cycle of the satellite or spacecraft, a higher end-of-charge voltage can increase the mission time of the satellite or spacecraft by providing more energy.

Advantageously, charging and discharging operation of the battery cells can be controlled and/or regulated by means of at least one regulation and/or control device, in particular by means of a microcontroller. In particular, a state of charge and/or an aging state of the battery cells can be determined by means of the regulation and/or control device. In particular, the regulation and/or control device can be designed to determine a state of charge and/or an aging state of the battery cells. In this way, the battery module can be monitored in detail and an overall condition of the battery system can be determined with a forecast for the further service life of the battery cells.

A battery module can advantageously communicate with other battery modules and/or a battery system using at least one CAN network. CAN networks are widespread communication applications, particularly in the automotive sector, which can also be used cost-effectively and very flexibly in battery systems.

Operating parameters of the battery module, in particular a state of charge and/or an aging state, can advantageously be exchanged with other battery modules. In this way, the battery system can be operated as cheaply as possible by adjusting the operating parameters of individual battery modules.

According to a further aspect of the invention, a method for operating a battery system with at least two autonomously operable battery modules is proposed, wherein end-of-charge voltages of the battery cells of battery modules are selected according to operating parameters and/or are adjusted by means of a unit for monitoring and charge balancing of battery cells of at least one battery module.

Above all, adaptive charge balancing, in which the end-of-charge voltage can be changed, is important for the operation of satellites. Here, a lower end-of-charge voltage can initially increase the lifespan of the battery cells. Later in the life cycle of the satellite or spacecraft, a higher end-of-charge voltage can increase the mission time of the satellite by providing more energy.

According to a favorable embodiment of the method, external communication of the battery system and/or internal communication between the battery modules can be carried out via at least one CAN network. CAN networks are widespread communication applications, particularly in the automotive sector, which can also be used cost-effectively and very flexibly in the battery system.

According to a favorable embodiment of the method, charging and discharging operation of the battery cells can be controlled and/or regulated by means of distributed communication with regulation and/or control devices of the individual battery modules. In particular, a state of charge and/or an aging state of the battery cells can be determined by means of the regulation and/or control device. In this way, the battery system can be monitored in detail and continued operation of the satellite can be ensured as cheaply as possible over the lifespan of the battery system.

According to a favorable embodiment of the method, a mutual check of the individual battery modules, in particular regarding a state of charge and/or an aging state, can be carried out via the regulation and/or control devices of the battery modules. In this way, favorable redundancy can be achieved when monitoring and controlling the battery system. This is particularly important in space applications, as failures of individual electronic components cannot be ruled out over the lifespan of the satellite due to the effects of the space environment.

### BRIEF DESCRIPTION OF THE DRAWINGS

Further advantages will be apparent from the following description of the drawings. Exemplary embodiments of the invention are shown in the figures. The figures, the description, and the claims contain numerous features in combination. A person skilled in the art will expediently also consider the features individually and combine them into further meaningful combinations.

In particular:

FIG. 1 shows a schematic side view of a stackable battery module for a battery system, in particular of a satellite, according to an exemplary embodiment of the invention;

FIG. 2 shows an isometric view of a stackable battery module with a termination board according to an exemplary embodiment of the invention;

FIG. 3 shows a side view of the battery module according to FIG. 2;

FIG. 4 shows a side view of the battery module according to FIG. 2;

FIG. 5 shows a cross section of the battery module along section line A-A according to FIG. 4;

FIG. 6 shows an isometric representation of a carrier board of a battery module according to an exemplary embodiment of the invention;

FIG. 7 shows a top view of a top side of the carrier board according to FIG. 6;

FIG. 8 shows a top view of a top side of the carrier board according to FIG. 6;

FIG. 9 shows a side view of the carrier board according to FIG. 6;

FIG. 10 shows an isometric representation of a battery system for a satellite with two battery modules according to an exemplary embodiment of the invention;

FIG. 11 shows a side view of the battery system of FIG. 10;

FIG. 12 shows another side view of the battery system according to FIG. 10;

FIG. 13 shows a cross section of the battery system along section line A-A according to FIG. 12;

FIG. 14 shows an electrical interconnection of two battery modules according to an exemplary embodiment of the invention;

FIG. 15 shows interfaces of two battery modules in a battery system according to an exemplary embodiment of the invention;

FIG. 16 shows a functional diagram of a regulation and/or control device of a battery module; and

FIG. 17 shows a system diagram of a battery module according to an exemplary embodiment of the invention.

### DETAILED DESCRIPTION

In the figures, identical or identically acting components are identified by the same reference numerals. The figures only show examples and are not to be understood as restrictive.

Directional terminology used in the following with terms such as “left”, “right”, “above”, “below”, “in front of”, “behind”, “after”, and the like only serves for better comprehension of the figures and is in no way intended to restrict the generality. The components and elements shown, their configuration and use can vary according to the considerations of a person skilled in the art and can be adapted to the respective applications.

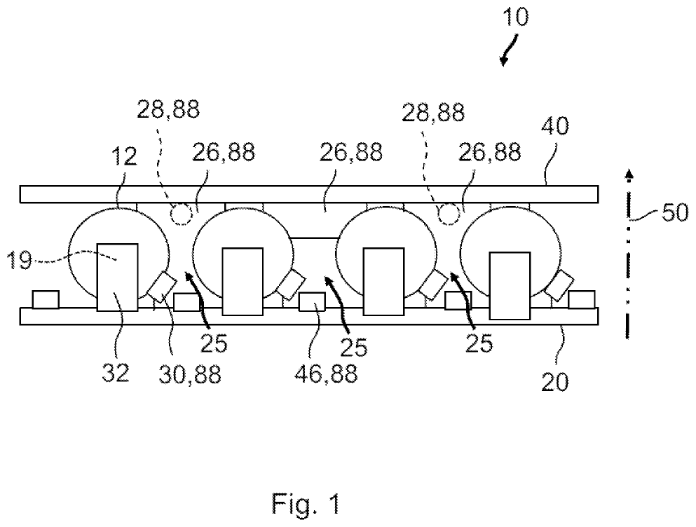

FIG. 1 shows a schematic side view of a stackable battery module 10 for a battery system 100, in particular of a satellite, according to an exemplary embodiment of the invention.

For the sake of clarity, reference numerals in the figures are only attached to individual components as examples and not to all of the same components.

The battery module 10 has a plurality of battery cells 12, which are arranged on a carrier board 20. Four battery cells 12 of which can be seen in the side view. The battery cells 12 in the illustrated exemplary embodiment are designed as cylindrical cells and are fixed lying on the carrier board 20. The battery cells 12 have connection poles 19 on the end faces, which are electrically connected to current paths of the carrier board 20 via cell connectors 32, for instance made of aluminum. Each connection pole 19 can be connected to a separate cell connector 32. The current paths of the carrier board 20 are accessible through slot-like receptacles 64 in the carrier board 20. At the top in the stacking direction 50, the battery module 10 is completed with a termination board 40.

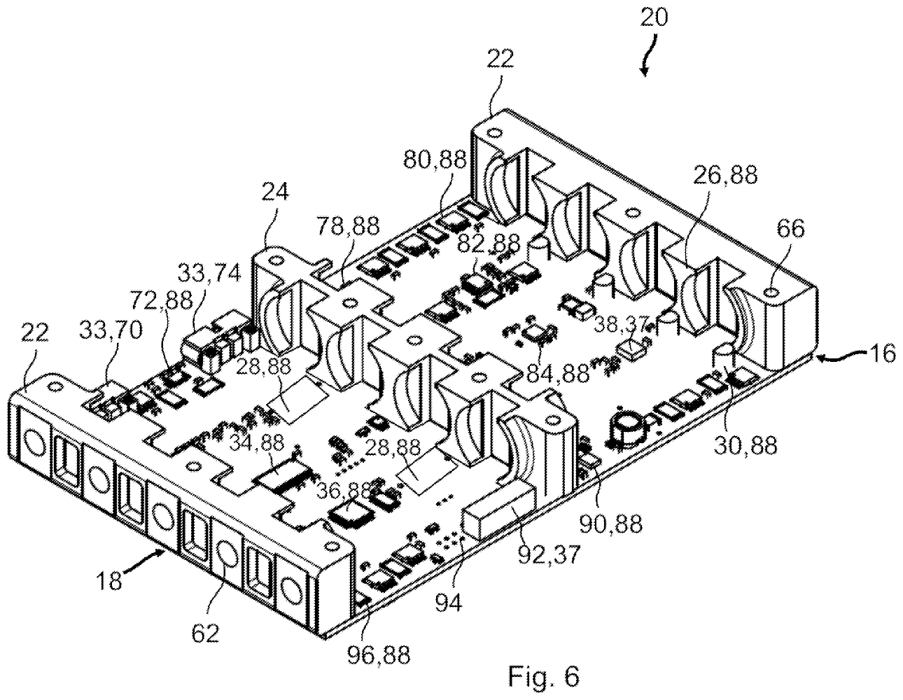

The carrier board 20 has operating components 88 for temperature control of the battery cells 12, for charge balancing between the battery cells 12, for monitoring the battery cells 12 and communication means 37 (FIG. 6) for communication with other battery modules 10 and/or the battery system 100.

Various electronic components 46 are arranged on the carrier board 20. Temperature sensors 30 are attached to each of the battery cells 12 and are thermally coupled directly to a housing of the battery cells 12.

Furthermore, connection means 33 for electrical series and/or parallel coupling with one or more other similar battery modules 10 are arranged on the carrier board 20. Connection means 33 can be, for example, the plug connectors 70, 74 of the positive power connection and ground connection as well as plug connectors 92 for data lines for controlling charge balancing of the battery cells.

On the one hand, battery modules 10 can be connected in parallel by connecting the plug connectors 70 of the positive power connection of each battery module and by connecting the plug connectors 74 of the ground connection of each battery module 10.

In addition, battery modules 10 can be connected in series in that the plug connector 74 of the ground connection of the first battery module acts as ground of the battery system 100. The plug connector 70 of the positive power connection of the first battery module 10 is then connected to the plug connector 74 of the ground connection of the next battery module 10 and so on. The plug connector 70 of the positive power connection of the last battery module 10 then serves as the positive power connection of the battery system. In addition, in the case of a serial connection, the modules 10 communicate/synchronize the charge balancing of the unit 34 for monitoring and/or charge balancing via the plug connectors 92 for data lines.

Between the battery cells 12, but in thermal contact with them, structural elements 26 are arranged, which serve to dissipate heat from the battery cells 12 and to heat the battery cells 12. For this purpose, for example, heating elements 28 can be integrated into the structural elements 26. For this purpose, the structural elements 26 are adapted to the external shape of the battery cells 12 and nestle against the battery cells 12.

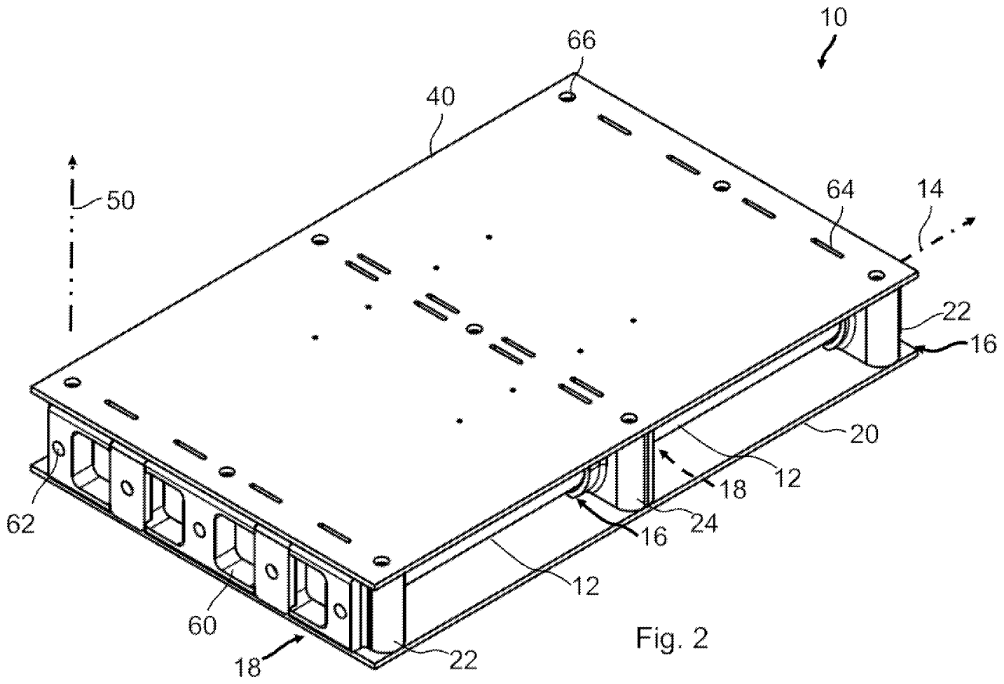

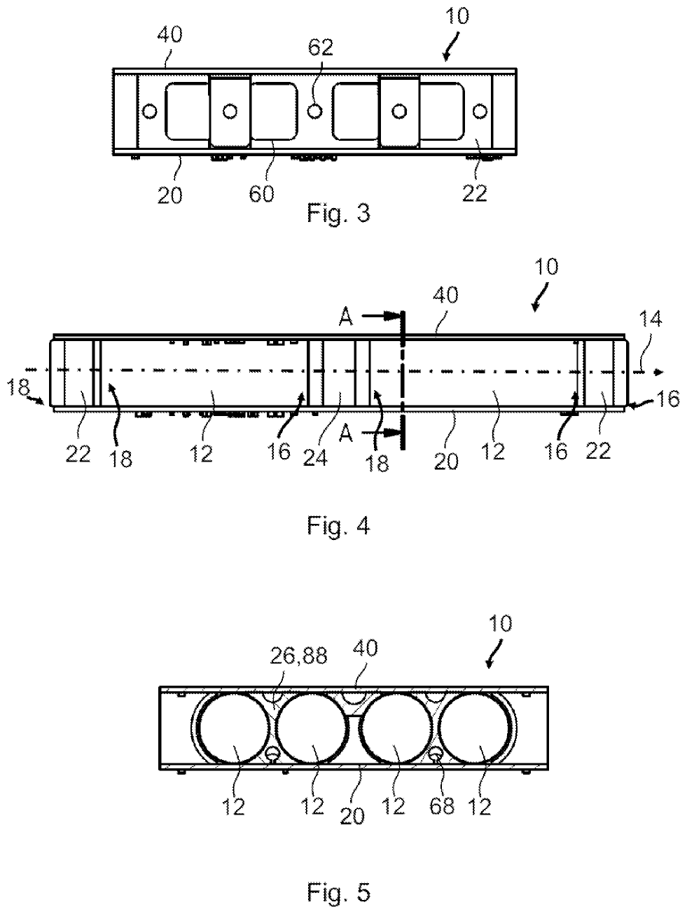

FIG. 2 shows an isometric view of a battery module 10 with a termination board 40 according to an exemplary embodiment of the invention. FIG. 3 shows a side view of the battery module 10 according to FIG. 2, while in FIG. 4 another side view of the battery module 10 according to FIG. 2 and in FIG. 5 a cross section of the battery module 10 along the section line A-A according to FIG. 4 is shown.

The battery module 10 includes eight battery cells 12, four cells 12 of which are arranged next to each other. The battery cells 12 are designed as cylindrical cells 12, which are arranged lying on the carrier board 20. As can be seen in particular in FIG. 4, the battery cells 12 are arranged next to one another and one behind the other with respect to a longitudinal axis 14. The battery cells 12 can each be electrically connected in parallel or in series. This is simplified by contacting each battery cell 12 with two cell connectors 32.

The carrier board 20 has first and second holding devices 22, 24, by means of which the battery cells 12 are fixed on the carrier board 20. The first holding devices are arranged on both side edges 16, 18 of the carrier board 20. A second holding device 24 in the middle of the battery module 10, as can be seen in FIG. 4, is designed to fix battery cells 12 arranged on both sides of the holding device 24.

The holding devices 22, 24 surround the battery cells 12 on opposite side edges 16, 18 of the carrier board 20 on their circumference at least in some regions, so that the battery cells 12 are securely fixed on the carrier board 12.

Mounting holes 66 are arranged on the top of the battery module 10 in the termination board 40, by means of which further battery modules 10 can be arranged stacked one on top of the other. Slots can also be seen in the termination board 40 as a receptacle 64 for cell connectors 32 for electrically contacting the battery cells 12.

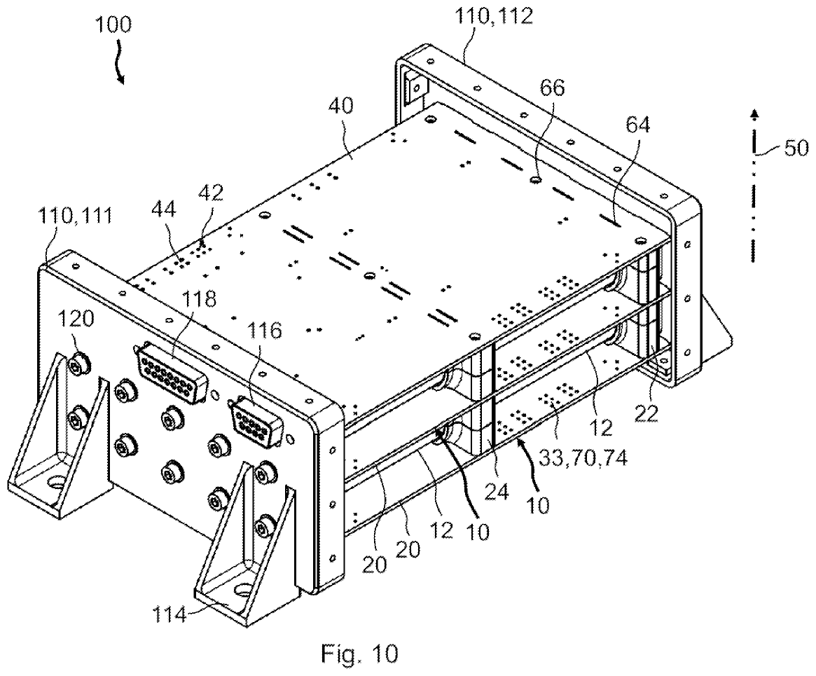

The holding devices 22 arranged at the two ends of the battery module 10 have mounting holes 62 for mechanically connecting the battery module 10 to a housing part 110, 112 of a battery system 100 (see FIG. 10). To save weight, the holding devices 22 are perforated with recesses 60.

Such battery modules can be interconnected in a suitable manner and form battery systems 100 with different voltage levels, different power, and/or different energy content.

As can be seen in the sectional view in FIG. 5, structural elements 26 are arranged on the carrier board 20 at least in regions between adjacent battery cells 12, which elements are designed to control the temperature of the battery cells 12, in particular to dissipate and supply heat. The structural elements 26 are at least partially adapted to an external shape of the battery cells 12. The structural elements 26 can be connected to the holding devices 22, 24.

In particular, the structural elements 26 can have a negative contour of the battery cells 12 in some regions and nestle up against the battery cells 12. Holes 68 for receiving heating elements 28 can be seen in the structural elements 26.

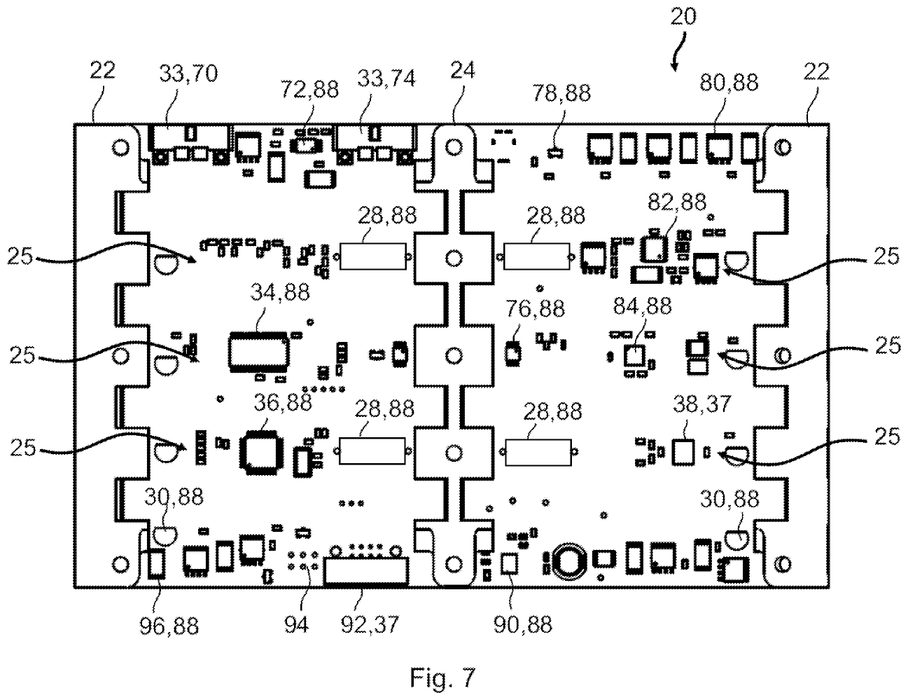

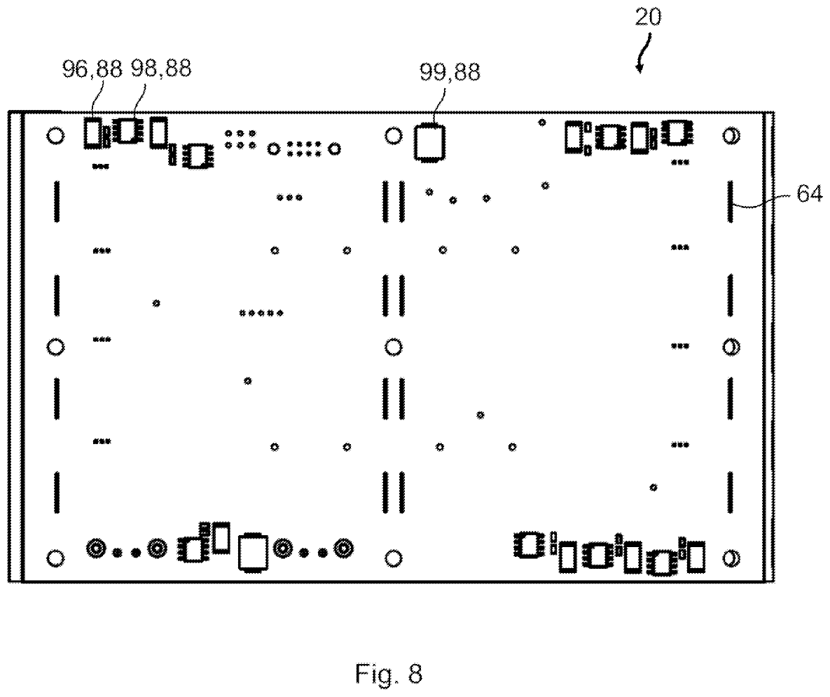

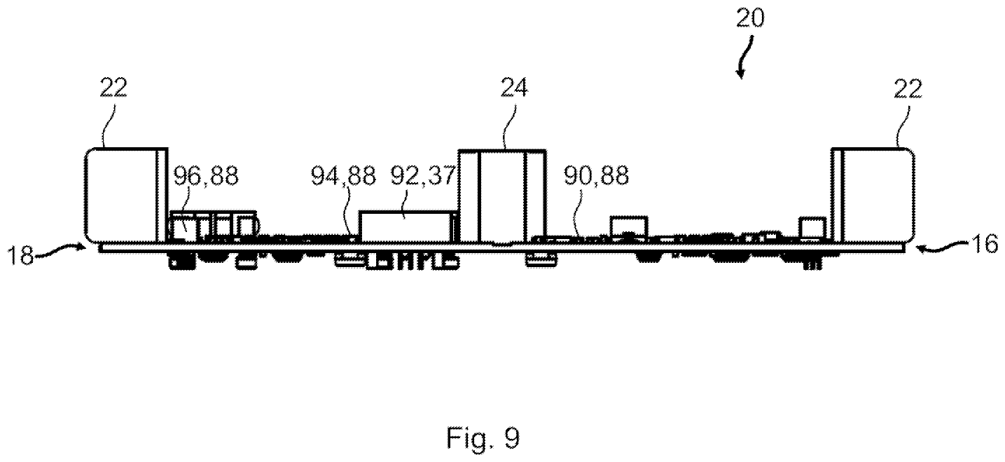

FIG. 6 shows an isometric representation of a carrier board 20 of a battery module 10 according to an exemplary embodiment of the invention. FIG. 7 shows a top view of a top side of the carrier board 20, while FIG. 8 shows a top view of an underside of the carrier board 20 and FIG. 9 shows a side view of the carrier board 20. The battery cells 12 of the battery module 10 are not shown.

In particular, the design of the first and second holding devices 22, 24 can be clearly seen in FIG. 6. The holding devices 22, 24 are designed, in order to accommodate the battery cells 12, according to the outer shape of the battery cells 12, cylindrical cells in the illustrated exemplary embodiments, so that the battery cells 12 are firmly fixed by the holding devices 22, 24. The middle second holding device 24 accommodates battery cells 12 from both sides. The structural elements 26 arranged between the battery cells 12 for dissipating heat from the battery cells 12 and for heating the battery cells 12 are integrated into the holding devices 22, 24 and can at the same time take on the function of fixing the battery cells 12.

The first and second holding devices 22, 24 of the carrier board 20 are designed for mechanical connection to a carrier board 20 of a further battery module 10 stacked above it and/or a termination board 40. For this purpose, the holding devices 22, 24 each have mounting holes 66 on their upper side for receiving screw connections.

At the ends of the long side of the battery module 10, the holding devices 22, 24 also have mounting holes 62 for connection to the housing parts 110, 112 of a battery system 100.

To heat the battery cells 12, the carrier board 20 has several (schematically indicated) heating elements 28, which can be pressed onto the battery cells 12 for good heat transfer. Alternatively, the heating elements 28 can also be integrated into the structural elements 26, for example via holes 68.

Advantageously, one respective heating element 28 can be provided for simultaneously heating of at least two adjacent battery cells 12 on the carrier board 20. For example, four heating elements 28 can be arranged in the middle of the carrier board 20 between the adjacent battery cells 12 in order to heat the eight battery cells 12 arranged on the carrier board 20.

The carrier board 20 has eight temperature sensors 30, which are provided for thermally contacting the battery cells 12. A temperature sensor 30 can thus advantageously be attached to each battery cell 12.

Electronic operating components 88, which are arranged on the carrier board 20, jointly perform tasks such as monitoring the battery module 10 and the battery cells 12, for example with voltage, current, temperature. Furthermore, an analysis of the battery module, for example a calculation of SOC and SOH of the battery cells, and/or a comparison of the values with set limits can be carried out.

The battery module 10 can be managed by controlling the charge balancing and heating of the battery cells 12. Electronic communication means 37 also communicate the data to the outside and process commands coming from the outside. The operating components 88 ensure protection of the electronics and battery cells 12 against faults and/or short circuits in semiconductors caused by radiation from space, so-called single event effects, or can also correct such errors under certain circumstances. Because the electronic operating components 88 are partially arranged under the battery cells 12, they can be additionally protected from cosmic radiation.

The carrier board 20 has, for example, at least one unit 34 for monitoring and balancing the charge of the battery cells 12 in a free space 25 between the battery cells 12. The unit 34 can advantageously be designed to selectably adjust an end-of-charge voltage of the battery cells 12.

Furthermore, the carrier board 20 has at least one regulation and/or control device 36 in a free space 25 between the battery cells 12, in particular a microcontroller, for controlling charging and discharging operation of the battery cells 12. The regulation and/or control device 36 can in particular be used to determine a state of charge and/or an aging state of the battery cells 12.

The carrier board 20 also has at least one CAN transceiver 38 in a free space 25 between the battery cells 12 for communication with other battery modules 10 and/or the battery system 100.

Furthermore, operating components 88 such as a current sensor 72, switching components such as a MOSFET 78 for a heating element 28, a MOSFET 80 for charge balancing, various integrated circuits 82, 84 for protecting the electronics, temperature sensors 76 and power converters 90 are arranged on the carrier board 20.

A plug connector 70 for the positive power connection of the battery module 10, a plug connector 74 for the ground connection, a plug connector 92 for data lines, and a plug connector 94 for so-called in-system programming (ISP) are also arranged on the top of the carrier board 20. During in-system programming, software is loaded onto the microcontroller of the regulation and/or control device 36, for example by flashing the memory.

For example, charge balancing ICs 98 are arranged on the back of the carrier board 20 shown in FIG. 8, which ICs take over the balancing if the smart balancing ICs 34 fail. The resistor 96 is then used for charge balancing. A transient voltage suppressor (TVS) diode 99 is also located on the back of the carrier board 20 and protects the lines of the power supply 158, 162, 92 and programming 94. On the one hand, the TVS diode 99 acts as a surge arrester for transient voltages and on the other hand, as protection against electrostatic discharge.

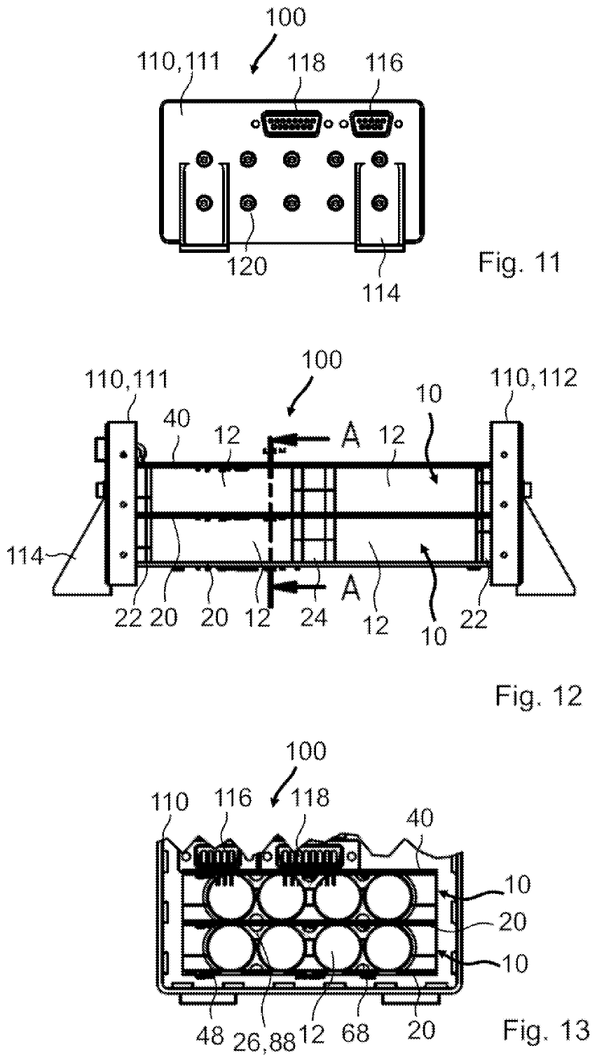

FIG. 10 shows an isometric representation of a battery system 100 for a satellite with two battery modules 10 according to an exemplary embodiment of the invention. A side view of the battery system 100 is shown in FIG. 11, while another side view of the battery system 100 is shown in FIG. 12 and a cross section of the battery system 100 along the section line A-A of FIG. 12 is shown in FIG. 13.

The battery system 100 comprises a battery housing 110 with two housing parts 111, 112 for accommodating the battery modules 10. The two housing parts 110, 112 are designed to accommodate two battery modules 10 stacked one above the other. The topmost battery module 10 in the stacking direction 50 is completed with a termination board 40, which is arranged on the holding devices 22, 24 of the topmost battery module 10.

The battery modules 10 are each mechanically connected to the two housing parts 110, 112 via screw connections 120 with the holding devices 22 of the carrier boards 20.

The housing parts 110, 112 have holders 114 for fixing with a mounting plate, in particular with a mounting plate of the satellite. Electrical plug connectors 116, 118 for power supply and/or for transmitting data are arranged on at least one of the two housing parts 110, 112.

The termination board 40 has an electrical connection 42 for an onboard data connection and/or an electrical connection 44 for programming the regulation and/or control device 36 of the battery modules 10, in particular a microcontroller.

The two battery modules 20 can be connected in parallel or in series by means of connection means 33, depending on the desired voltage level, and/or power, and/or capacity of the battery system 100. Connection means 33 can be, for example, the plug connectors 70, 74 of the positive power connection and ground connection as well as plug connectors 92 for data lines for controlling charge balancing of the battery cells.

On the one hand, battery modules 10 can be connected in parallel by connecting the plug connectors 70 of the positive power connection of each battery module and by connecting the plug connectors 74 of the ground connection of each battery module 10.

In addition, battery modules 10 can be connected in series in that the plug connector 74 of the ground connection of the first battery module 10 acts as ground of the battery system 100. The plug connector 70 of the positive power connection of the first battery module is then connected to the plug connector 74 of the ground connection of the next battery module 10 and so on. The connector 70 of the positive power connection of the last battery module 10 then serves as the positive power connection of the battery system. In addition, in the case of a series connection, the modules communicate/synchronize the charge balancing of the unit 34 for monitoring and/or charge balancing via the plug connectors 92 for data lines.

The voltage of the battery system 100 is equal to the voltage of a battery module 10 multiplied by the number of battery modules connected in series.

The maximum current strength and capacity of the battery system 100 is equal to the current strength or the capacity of a battery module 10 multiplied by the number of battery modules 10 connected in parallel.

The voltage or current and capacity can then be increased together using a combination of parallel and series connection.

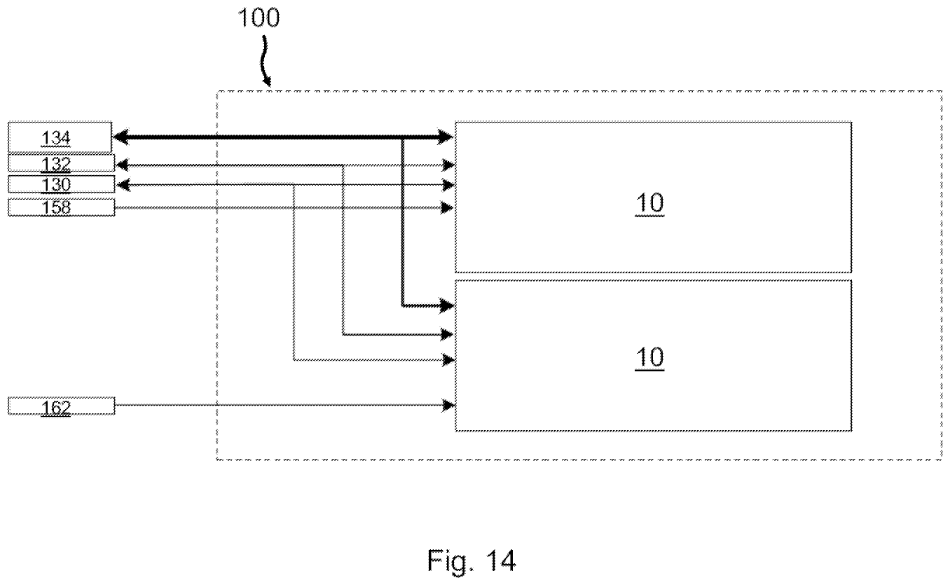

FIG. 14 shows an electrical connection of two battery modules 10 of a battery system 100 according to an exemplary embodiment of the invention.

The two battery modules 10 are connected in parallel to supply voltages or data lines. For example, a non-regulated power supply (24V-34V) is provided Furthermore, the two battery modules 10 are connected to a CAN line 132, an inter-integrated circuitline 130 (I2C line) and to separate 28 V power supplies 158, 162. The I2C line 130 is used for the electrical coupling of additional temperature sensors, which can be read directly from the outside, for example by satellite computers, in the event of errors in the system.

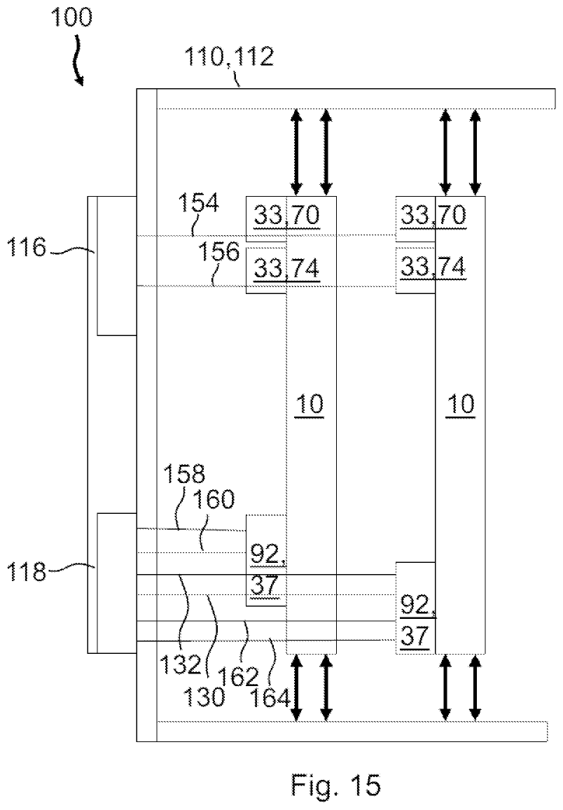

FIG. 15 shows interfaces of two battery modules 10 in a battery system 10 according to an exemplary embodiment of the invention.

In this schematic representation, two battery modules 10 are connected to housing parts 110, 112 of the battery system 100 via mechanical and thermal interfaces, which are symbolically shown as arrows.

The battery system 100 has plug connectors 116, 118 for power supply or data. Corresponding power connection lines 154 and ground lines 156 are connected to corresponding plug connectors 70, 74 of the battery modules 10.

The plug connector 118 for data leads 28 V lines 158, 162 and ground lines 160 separately to connectors 92 for data lines of the battery modules 10, while the CAN line 132 and I2C line 130 are connected in parallel to the battery modules 10.

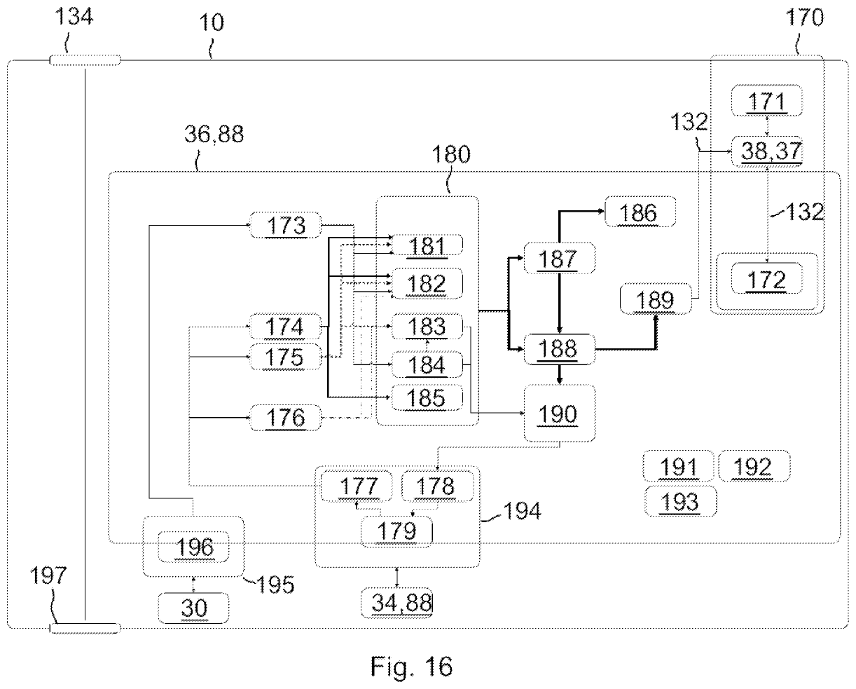

FIG. 16 shows a functional diagram of a regulation and/or control device 36 of a battery module 10.

As previously shown, the battery module 10 has an interface 134 for the power supply. Furthermore, the battery module 10 has an interface 197 of the cell string, whereby a cell string is understood to be a combination of series and parallel connection of the battery cells 12.

The regulation and/or control device 36 processes information from the temperature sensors 30, which are supplied in the form of a single-wire temperature sensor 195 via a single-wire communication 196.

The unit 34 for monitoring and/or charge balancing is integrated via the communication interface 194. In this case, an SPI message is decoded via a so-called serial peripheral interface communication 179 (SPI communication) in the function 177, which is fed as a string current 174, string voltage 175, individual cell voltages 176 to a central function 180 for estimating a battery status and monitoring limits.

In the central function 180, monitoring limits for voltage, current and temperature are determined in function 181, and an SOC per string is determined in function 182. Furthermore, voltage limits per string are tested in function 183, temperature limits are tested per string in function 184, and current limits are tested per string in function 185.

From functions 183, 184, 185, a target voltage for the charge balancing per battery cell 12 is defined in function 190, which voltage is again coded as an SPI message in a function 178 and sent to the SPI communication 179 of unit 34 for monitoring and/or voltage balancing.

From the central function 180, further information is derived for a function 187 of an error management of a function 186 of a heating control. This error management 187 continues to flow as input into a state machine 188, which derives a general status message from it in function 189. Information from state machine 199 also flows into the definition of the target voltages for charge balancing in function 190.

The status message from function 189 can be routed via a CAN line 132 to a CAN transceiver 38 of the CAN communication 170, which is controlled by a CAN transmit/receive module 171. A decoder 172 of received CAN messages is connected to the CAN transceiver 38 via a CAN line 132.

The regulation and/or control device 36 further comprises a general function 191 for initialization and configuration, an interrupt handling 192 and a watchdog 193.

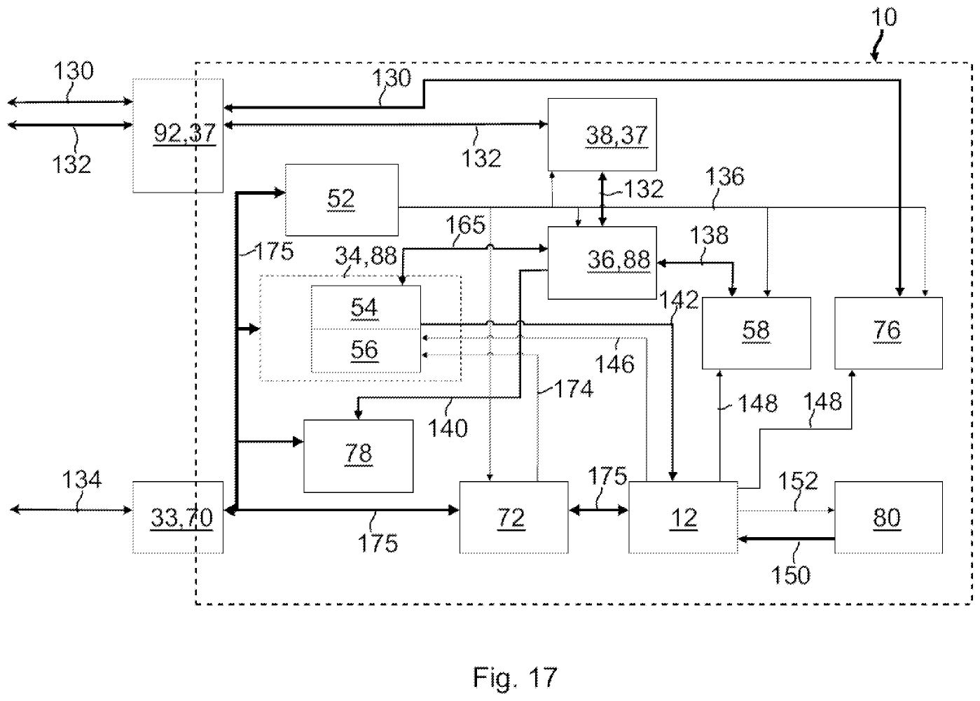

FIG. 17 shows a system diagram of a battery module 10 according to an exemplary embodiment of the invention.

The battery module 10 has a plug connector 92 for data lines 130, 132 and a plug connector 70 for the positive power connection 154.

The string voltage 175 of the battery cells 12 is fed in parallel to a 3.3 V supply unit 52, to the unit 34 for monitoring and/or charge balancing, to a MOSFET 78 for a heating element 28, and to a current sensor 72.

The 3.3 V line is connected from the 3.3 V supply unit 52 to the temperature measuring unit 58, to the temperature sensor 76 and to the current sensor 72.

The I2C line 130 goes from plug connector 92 to temperature sensor 76. The CAN line 132 leads to the CAN transceiver 38 and from there to the central microprocessor of the regulation and/or control device 36.

The regulation and/or control device 36 is connected via SPI communication 165 to the unit 34 for monitoring and/or charge balancing, which comprises units for voltage measurement 54 and for charge balancing 56. The voltage measurement 54 is connected directly to the battery cells 12 via the FET controller 142 for charge balancing. A line 146 for measuring the individual cell voltage leads from the battery cells 12 back to the charge balancing function 56.

A line 174 for the current signal of the current through the cell string also leads from the current sensor 72 to the charge balancing function 56.

The MOSFET 78 for the heater is controlled via line 140 by the regulation and/or control device 36. A bus line 138 leads from the regulation and/or control device 36 to the temperature measuring unit 58. The temperature sensors 76 receive their signal of the individual cell temperatures via the line 148, as does the temperature measuring unit 58

The MOSFET 80 for charge balancing receives a signal via the individual cell connection 152 and is in turn connected to the battery cells 12 via a series resistor 150.

Advantageously, in the proposed battery module 10, an end-of-charge voltage of the battery cells 12 can be selected according to operating parameters and/or set by means of the unit 34 for monitoring and charge balancing of battery cells 12.

Advantageously, charging and discharging operation of the battery cells 12 can be controlled and/or regulated by means of at least one regulation and/or control device 36, in particular by means of a microcontroller. In particular, a state of charge and/or an aging state of the battery cells 12 can be determined by means of the regulation and/or control device 36.

It is convenient to communicate with other battery modules 10 and/or a battery system 100 using a CAN network. Operating parameters of the battery module 10, in particular a state of charge and/or an aging state, can advantageously be exchanged with other battery modules.

In a battery system 100, both external communication of the battery system 100 and internal communication between the battery modules 10 can be carried out via the CAN network.

The charging and discharging operation of the battery cells 12 of the battery system 100 can be controlled and/or regulated by means of distributed communication with the regulation and/or control devices 36 of the individual battery modules 10. In particular, a state of charge and/or an aging state of the battery cells 12 can be determined by means of the regulation and/or control device 36 of the individual battery modules 10.

In the battery system 100, a mutual check of the individual battery modules 10, in particular regarding a state of charge and/or an aging state, can advantageously be carried out via the regulation and/or control devices 36 of the battery modules 10.

### LIST OF REFERENCE NUMERALS

10 battery module
12 battery cell
14 longitudinal axis
16 end, end face
18 end, end face
19 connection pole
20 carrier board
22 holding device
24 holding device
25 free space
26 structural element
28 heating element
30 temperature sensor
32 cell connector
33 connection means
34 unit for monitoring and/or charge balancing
36 regulation and/or control device
37 communication means
38 CAN transceiver
40 termination board
42 electrical connection of onboard data connection
44 electrical connection for programming
46 electronic component
48 battery cell recess
50 stacking direction
52 3.3V power supply
54 voltage measurement
56 charge balancing
58 temperature measurement unit
60 recess
62 mounting hole
64 receptacle for cell connector
66 mounting hole
68 hole for heating element
70 plug connector power connection positive
72 current sensor
74 plug connector power connection ground
76 temperature sensor
78 MOSFET heater
80 MOSFET charge balancing
82 protection IC
84 Protection IC
88 operational component
90 power converter
92 plug connector data lines
94 ISP plug connectors
96 resistor for charge balancing
98 redundant charge balancing IC
99 TVS diode
100 battery system
110 battery housing
111 housing part
112 housing part
114 holder
116 plug connector for power supply
118 plug connector for data
120 screw connection of holding device
130 I2C
132 CAN
134 power supply
136 3.3V line
138 bus line
140 FET control heating
142 FET control charge balancing
146 measurement of single cell voltage
148 individual cell temperature
150 series resistor
152 individual cell connection
154 power connection
156 ground connection
158 28V
160 ground line
162 28V
164 ground line
165 SPI communication
170 CAN transceiver
171 CAN transmitter/receiver module
172 decoder for CAN messages
173 cell temperature
174 string current
175 string voltage
176 cell voltage
177 decode SPI message
178 encode SPI message
179 SPI communication
180 estimate battery status & monitoring limits
181 calculate monitoring limits
182 determine SOC per string
183 test voltage limit per string
184 test temperature limit per string
185 test current limit per string
186 heating control
187 error management
188 state machine
189 generate status message
190 define target voltage per cell for charge balancing
191 initialize & configure
192 interrupt handling
193 watchdog
194 communication with charge balancing unit
195 single wire temperature sensor
196 single wire communication
197 cell string interface

1. An autonomously operable battery module for a battery system of a satellite or spacecraft, with a carrier board on which a plurality of battery cells and operating components for temperature control of the battery cells, for charge balancing between the battery cells and for monitoring the battery cells are arranged,
wherein communication means are also present on the carrier board for communication with the battery system and further battery modules in the battery system,
and connection means for electrical series and/or parallel coupling with one or more other similar battery modules are arranged on the carrier board.

2. The battery module according to claim 1, wherein the carrier board has first and second holding devices and the battery cells are clamped between a first and a second holding device.

3. The battery module according to claim 1, wherein one of the first holding devices is arranged on opposite side edges of the carrier board.

4. The battery module according to claim 1, wherein the second holding devices are arranged between the first holding devices.

5. The battery module according to claim 1, wherein the battery cells are arranged lying on the carrier board.

6. The battery module according to claim 1, wherein the battery cells are arranged next to one another and/or one behind one another with respect to their longitudinal axis, wherein the battery cells on the carrier board are electrically interconnected or can be interconnected in parallel and/or series.

7. The battery module according to claim 1, wherein structural elements are arranged at least in regions between adjacent battery cells, which elements are designed for passive temperature control of the battery cells, wherein the structural elements are adapted, at least in regions, to an external shape of the battery cells.

8. The battery module according to claim 7, wherein the structural elements are integrated into the holding devices.

9. The battery module according to claim 7, wherein the carrier board has one or more heating elements.

10. The battery module according to claim 9, wherein one heating element is respectively provided for simultaneously heating at least two adjacent battery cells on the carrier board.

11. The battery module according to claim 1, wherein the carrier board has one or more temperature sensors (30) which are provided for thermally contacting the battery cells.

12. The battery module according to claim 1, wherein connection poles of the battery cells are electrically connected to current paths of the carrier board by means of cell connectors (32).

13. The battery module according to claim 1, wherein the carrier board has at least one unit for monitoring and balancing the charge of the battery cells in at least one free space between the battery cells.

14. The battery module according to claim 1, wherein the carrier board has at least one regulation and/or control device, in at least one free space between the battery cells for controlling a charging and discharging operation of the battery cells.

15. The battery module according to claim 1, wherein the carrier board has at least one CAN transceiver in at least one free space between the battery cells for communication with other battery modules and/or the battery system.

16. The battery module according to claim 2, wherein the first and second holding devices of the carrier board are designed for mechanical connection to a carrier board of a further battery module stacked above it and/or to a termination board.

17. A battery system of a satellite or spacecraft, with at least two autonomously operable battery modules according to claim 1,
wherein the at least two battery modules are constructed identically and each have a carrier board on which a plurality of battery cells and operating components for temperature control of the battery cells, for charge balancing between the battery cells and for monitoring the battery cells are arranged,
wherein communication means are also present on the carrier board for communication with the battery system and the at least one further battery module in the battery system,
wherein the at least two battery modules are electrically coupled in series and/or parallel by means of connection means which are arranged on the carrier board.

18. The battery system according to claim 17, wherein the at least two battery modules are arranged in a battery housing.

19. The battery system according to claim 17, wherein the battery housing has respective holders for fixing to a mounting plate and/or wherein the battery housing has at least one electrical plug connector for power supply and/or for transmitting data.

20. The battery system according to claim 18, wherein the termination board has at least one electrical connection for an onboard data connection and/or an electrical connection for programming a regulation and and/or control device.

21. A method for operating a battery system according to claim 17, with at least two autonomously operable battery modules, wherein end-of-charge voltages of the battery cells of battery modules are selected according to operating parameters and/or are set by means of a unit for monitoring and balancing the charge of battery cells of at least one battery module.

22. The method according to claim 21, wherein external communication of the battery system and/or an internal communication between the battery modules is carried out via at least one CAN network.

23. The method according to claim 21, wherein a charging and discharging operation of the battery cells is controlled and/or regulated by means of distributed communication with regulation and and/or control devices of the individual battery modules.

24. The method according to claim 21, wherein a mutual check of the individual battery modules is carried out via the regulation and/or control devices of the battery modules.
